(19) United States
(12) Patent Application Publication
(10) Pub. No.: US 2013/0293721 A1
(43) Pub. Date: Nov. 7, 2013

(54) IMAGING APPARATUS, IMAGING METHOD, AND PROGRAM

(71) Applicant: Yusuke Takahashi, Tokyo (JP)

(72) Inventor: Yusuke Takahashi, Tokyo (JP)

(73) Assignee: NEC CORPORATION, Tokyo (JP)

(21) Appl. No.: 13/979,952

(22) PCT Filed: Dec. 16, 2011
(86) PCT No.: PCT/JP2011/079178

§ 371 Date: Jul. 16, 2013

(30) Foreign Application Priority Data
Mar. 17, 2011 (JP) 2011-058973

(51) Int. Cl. H04N 7/18

(52) U.S. Cl. CPC H04N 7/181
USPC 348/159

(57) ABSTRACT

Provided is an imaging apparatus capable of determining a parameter relating to image processing without setting the parameter required for the image processing for each camera unit. An imaging camera information storage unit stores imaging camera information including arrangement information and functional information of a camera unit. An installation information acquiring unit acquires installation information of an imaging unit. An environmental information acquiring unit acquires environmental information surrounding the imaging unit. A parameter determination unit determines a parameter of image processing based on the imaging camera information, the installation information, and the environmental information. An image processing unit performs image processing based on the determined parameter.

### TECHNICAL FIELD

The present invention relates to an imaging apparatus, an imaging method, and a program.

### BACKGROUND ART

For applications such as surveillance, care, or marketing, there are demands for easily realizing systems that perform monitoring over a particular area. Since existing systems (video camera products) generally perform monitoring using a single lens at a fixed angle, blind spots arise.

Therefore, in order to eliminate blind spots, monitoring using a plurality of camera units has been proposed. However, there are problems involved in arrangement of camera units, layout of cables, and so forth at the time of installing a system. Thus, in order to avoid the problems involved in arrangement of camera units, layout of cables, and so forth at the time of installing a system, Patent Documents 1 and 2 propose omnidirectional imaging apparatuses in which a plurality of lenses are mounted in a single device.

### PRIOR ART DOCUMENTS

### Patent Documents

Patent Document 1: Japanese Unexamined Patent Application, First Publication No. 2001-117187

Patent Document 2: Japanese Unexamined Patent Application, First Publication No. 2007-135176

### SUMMARY OF INVENTION

Problem to be solved by the Invention

However, with the above-described technology disclosed in Patent Documents 1 and 2, it is necessary to set up parameters and so forth that are used for image processing for each of camera units in accordance with the installed positions of the camera units, the surrounding environment, and so forth, so that there is a problem in that extremely troublesome work is required.

An exemplary object of the present invention is to provide an imaging apparatus, an imaging method, and a program that are capable of solving the above-described problem.

### Means for Solving the Problem

In order to solve the above-described problem, the present invention is an imaging apparatus which includes: an imaging unit which includes one or a plurality of camera units and performs capturing; an imaging camera information storage unit which stores imaging camera information which includes at least arrangement information and functional information of the one or the plurality of camera units; an installation information acquiring unit which acquires installation information of the imaging unit; an environmental information acquiring unit which acquires environmental information surrounding the imaging unit; a parameter determination unit which determines a parameter of image processing for the one or the plurality of camera units based on the imaging camera information, the installation information, and the environmental information; and an image processing unit which performs image processing on video taken using the one or the plurality of camera units of the imaging unit, based on the parameter determined by the parameter determination unit.

Moreover, in order to solve the above-described problem, the present invention is an imaging method which includes: storing imaging camera information including at least arrangement information and functional information of one or a plurality of camera units that are provided in an imaging unit; acquiring installation information of the imaging unit; acquiring environmental information surrounding the imaging unit; determining a parameter of image processing for the one or the plurality of camera units based on the imaging camera information, the installation information, and the environmental information; capturing video using the imaging unit; and performing image processing on video taken using the one or the plurality of camera units of the imaging unit based on the determined parameter.

Furthermore, in order to solve the above-described problem, the present invention is a program which causes a computer of an imaging apparatus to execute: an imaging function of capturing video using an imaging unit that includes one or a plurality of camera units; an imaging camera information storage function of storing imaging camera information including at least arrangement information and functional information of the one or the plurality of camera units; an installation information acquiring function of acquiring installation information of the imaging unit; an environmental information acquiring function of acquiring environmental information surrounding the imaging unit; a parameter determination function of determining a parameter of image processing for the one or the plurality of camera units based on the imaging camera information, the installation information, and the environmental information; and an image processing function of performing image processing on video taken using the one or the plurality of camera units of the imaging unit based on the parameter determined by the parameter determination function.

### Exemplary Advantageous Effects of the Invention

With the present invention, it is possible to determine parameters relating to image processing without setting the parameters required for the image processing for each of camera units.

### BRIEF DESCRIPTION OF DRAWINGS

FIG. 1 is a block diagram illustrating a configuration of an imaging apparatus in accordance with a first exemplary embodiment of the present invention.

FIG. 2 is a flowchart describing an operation of the imaging apparatus in the first exemplary embodiment.

FIG. 3 is a conceptual diagram illustrating a method for acquiring the height at which a camera is installed, as installation information, in the first exemplary embodiment.

FIG. 4 is a conceptual diagram illustrating a method for acquiring the height at which a camera is installed, as installation information, in the first exemplary embodiment.

FIG. 5A is a conceptual diagram describing the fact that the shape of a person varies depending on an angle of depression of an installed camera housing in the first exemplary embodiment.

FIG. 5B is a conceptual diagram describing the fact that the shape of a person varies depending on an angle of depression of an installed camera housing in the first exemplary embodiment.

FIG. 6 is a block diagram illustrating a configuration of an imaging apparatus in accordance with a second exemplary embodiment of the present invention.

FIG. 7 is a flowchart describing an operation of the imaging apparatus in the second exemplary embodiment.

FIG. 8 is a descriptive diagram illustrating an example of arrangement of a plurality of camera units in the second exemplary embodiment.

### MODES FOR CARRYING OUT THE INVENTION

Hereinafter, exemplary embodiments of the present invention will be described with reference to the drawings.

### A. First Exemplary Embodiment

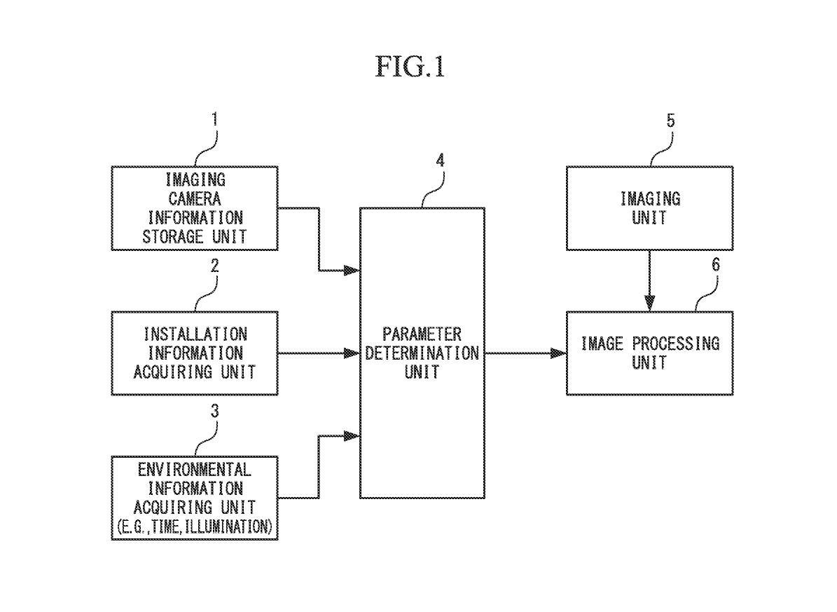

FIG. 1 is a block diagram illustrating a configuration of an imaging apparatus in accordance with a first exemplary embodiment of the present invention. In FIG. 1, the imaging apparatus includes an imaging camera information storage unit 1, an installation information acquiring unit 2, an environmental information acquiring unit 3, a parameter determination unit 4, an imaging unit 5, and an image processing unit 6. The imaging camera information storage unit 1 stores imaging camera information relating to the shape and the size of a camera housing, specifications of installed camera units, such as the number of the camera units, the positions of the camera units, the numbers of pixels of the camera units, the focal lengths of the camera units, or camera lens distortion parameters of the camera units, and positional information of the camera units relative to the camera housing. The installation information acquiring unit 2 acquires installation information of the camera housing. For example, the installation information includes the height at which the camera housing is installed, the position of the camera housing, the orientation of the camera housing, and so forth.

The environmental information acquiring unit 3 acquires environmental information relating to the surrounding environment in which the camera housing is installed. The environmental information includes, for example, the date and time, discrimination between an indoor area and an outdoor area, illumination conditions, a rough sketch of a room in the case of the indoor area, map information including surrounding buildings and so forth in the case of the outdoor area. The parameter determination unit 4 estimates, for example, the perspective of an object that is an imaging target (a processing target) within an angle of view of each camera unit, based on the information from the imaging camera information storage unit 1, the installation information acquiring unit 2, and the environmental information acquiring unit 3 (the imaging camera information, the installation information, and the environmental information), and determines parameters suitable for processes performed by the image processing unit 6. The imaging unit 5 acquires video from the camera units installed in the camera housing. The image processing unit 6 performs image processing on each of images that configure the video acquired by the imaging unit 5, based on the parameters determined by the parameter determination unit 4.

Next, an operation of the present first exemplary embodiment will be described.

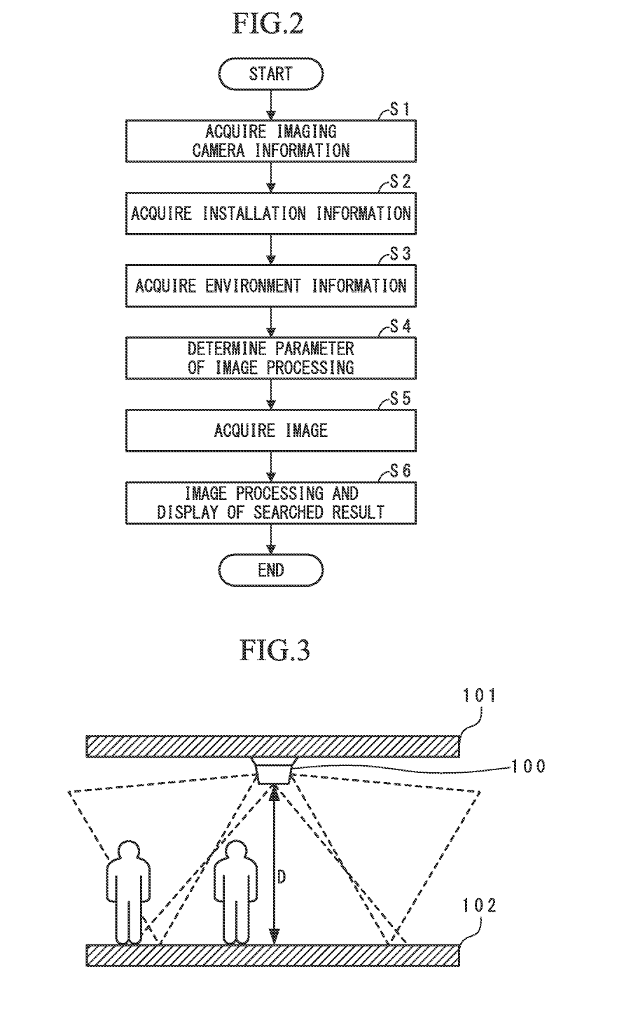

FIG. 2 is a flowchart describing the operation of the imaging apparatus in accordance with the present first exemplary embodiment. First, the parameter determination unit 4 acquires, from the imaging camera information storage unit 1, the specifications of one or a plurality of camera units installed in the camera housing as well as the positional information of the camera units relative to the camera housing (step S1).

It is to be noted that the imaging camera information storage unit 1 may be embedded in the camera housing, or it may be, for example, a storage apparatus from which information can be acquired via signal lines. The imaging camera information includes the shape and the size of the camera housing, CAD (computer aided design) data relating to the positions of the installed camera units, and information on the camera units, such as lenses, CCD (charge coupled device) imaging devices, or internal calibration data of the cameras.

Next, the installation information acquiring unit 2 acquires installation information of the camera housing (step S2). For example, the installation information acquiring unit 2 acquires, as the installation information, the height at which the camera housing is installed, and the position, the orientation, and the attitude of the camera housing. The orientation and the attitude of the camera housing can be obtained from a gravity sensor or a sensor such as an electronic compass that is embedded in the camera housing.

For example, when a camera housing 100 is installed on a ceiling 101 as shown in FIG. 3, the installation information acquiring unit 2 is provided with a distance sensor, and the installation information acquiring unit 2 calculates the distance D to a floor 102 using the distance sensor, as the information on the height at which the camera is installed. Alternatively, the height at which the camera is installed may be obtained using a method other than the method using the distance sensor; for example, a plurality of camera units installed in the camera housing 100 may capture a common object (in the illustrated example, around the feet of a person), and calculate the distance D to the floor 102 based on camera coordinate values of the object using a stereo matching method (a method for calculating a distance based on parallaxes in a plurality of cameras).

Moreover, the imaging apparatus accepts, from a user, an input of information on discrimination between an indoor area and an outdoor area in advance, as installed position information of the camera housing 100. Alternatively, the installation information acquiring unit 2 may acquire information on temperature, humidity, wind velocity, and so forth, calculate rates of change in the temperature, the humidity, and the wind velocity, and discriminate between an indoor area and an outdoor area.

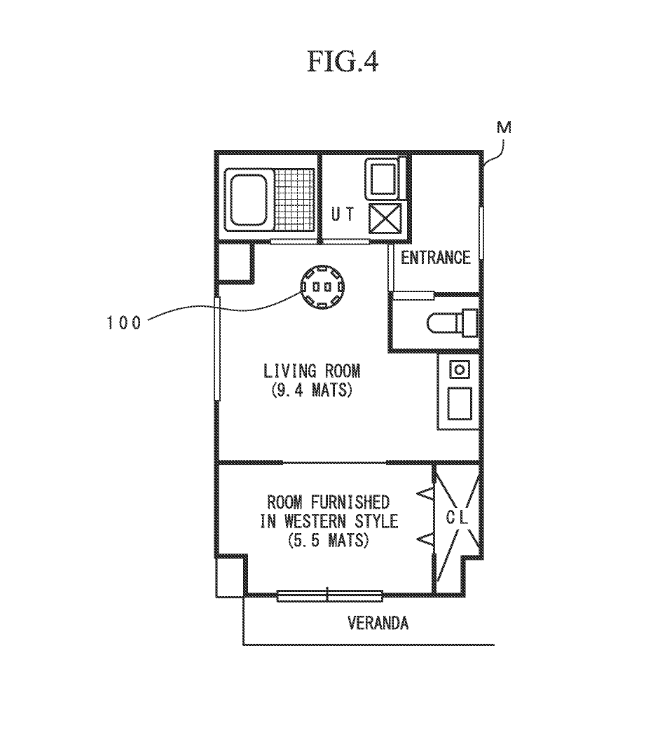

Furthermore, as for the installed position of the camera housing 100, when, for example, there is a rough sketch M as shown in FIG. 4, the imaging apparatus accepts, from the user, an input representing the installed position of the camera housing 100 on the rough sketch M in advance. Alternatively, the installation information acquiring unit 2 may acquire CAD data of the rough sketch M, extract characteristic portions such as four corners or doors of a room, and calculate the installed position of the camera housing 100 in the rough sketch based on the positional relationship therebetween.

Additionally, even when there is no CAD data of the rough sketch M, a dictionary relating to structures having typical shapes, such as a kitchen, a door, or a window, may be created in advance, the structures may be automatically recognized based on the video from the camera units using the dictionary, and the installed position of the camera housing 100 in the rough sketch M may be calculated from the relative positional relationship between the camera housing 100 and the structures on the rough sketch M.

Next, the environmental information acquiring unit 3 acquires environmental information on the surrounding environment in which the camera housing 100 is installed (step S3). The environmental information acquiring unit 3 acquires illumination information around the camera housing 100 using information on the date and time, information on the position of the sun, and weather information, in addition to the information on an indoor area/an outdoor area acquired by the installation information acquiring unit 2 and the rough sketch M of the room.

For example, the environmental information acquiring unit 3 calculates the amount of rays of the sun that come into the room based on the orientation of the room and the positions of windows on the rough sketch M of the room. Alternatively, in the state in which the camera units are installed, seasonal or temporal illumination conditions in the installed environment may be obtained by acquiring changes in the brightness values in the camera units in days or in years.

Next, the parameter determination unit 4 estimates the perspective and so forth of an object that is a processing target of each camera unit within an angle of view based on the information of the imaging camera information storage unit 1, the installation information acquiring unit 2, and the environmental information acquiring unit 3 (the imaging camera information, the installation information, and the environmental information), and determines parameters suitable for the processes performed by the image processing unit 6 (step S4).

Here, it is conceivable that the environmental information acquired by the environmental information acquiring unit 3 dynamically varies from moment to moment. Thus, the parameter determination unit 4 determines the parameters dynamically.

The processes performed by the image processing unit 6 include, for example, detection of a person.

A method for detecting a person in the image processing unit 6 may employ background subtraction, or it may use the shape of a person. In a method using background subtraction, the size of a person in an image of each camera unit can be estimated from the imaging camera information and the installation information, and thus the size of the person is determined as a parameter.

For example, the image processing unit 6 assumes that the size of a person is equal to that of a cylinder having a diameter of 50 cm and a height of 170 cm, and acquires the installed positions of the cameras and coordinate points on the cylinder disposed in the rough sketch M of the room in a global coordinate system that is set from the rough sketch M, from coordinate values that have been converted into a camera coordinate system, using the internal calibration data of the cameras that has been obtained in advance.

For example, when a plurality of camera units are installed downward relative to the camera housing 100, the distance from the camera housing 100 to the head of the person is extracted using, for example, the stereo matching method. Then, the stature of the person is estimated using the difference between the distance D from the camera housing 100 to the surface of a floor obtained by the installation information acquiring unit 2 and the distance to the head of the person. With information of the estimated stature, it is possible to estimate the size of the person more accurately than in the case in which the stature is assumed to be 170 cm in the other camera units.

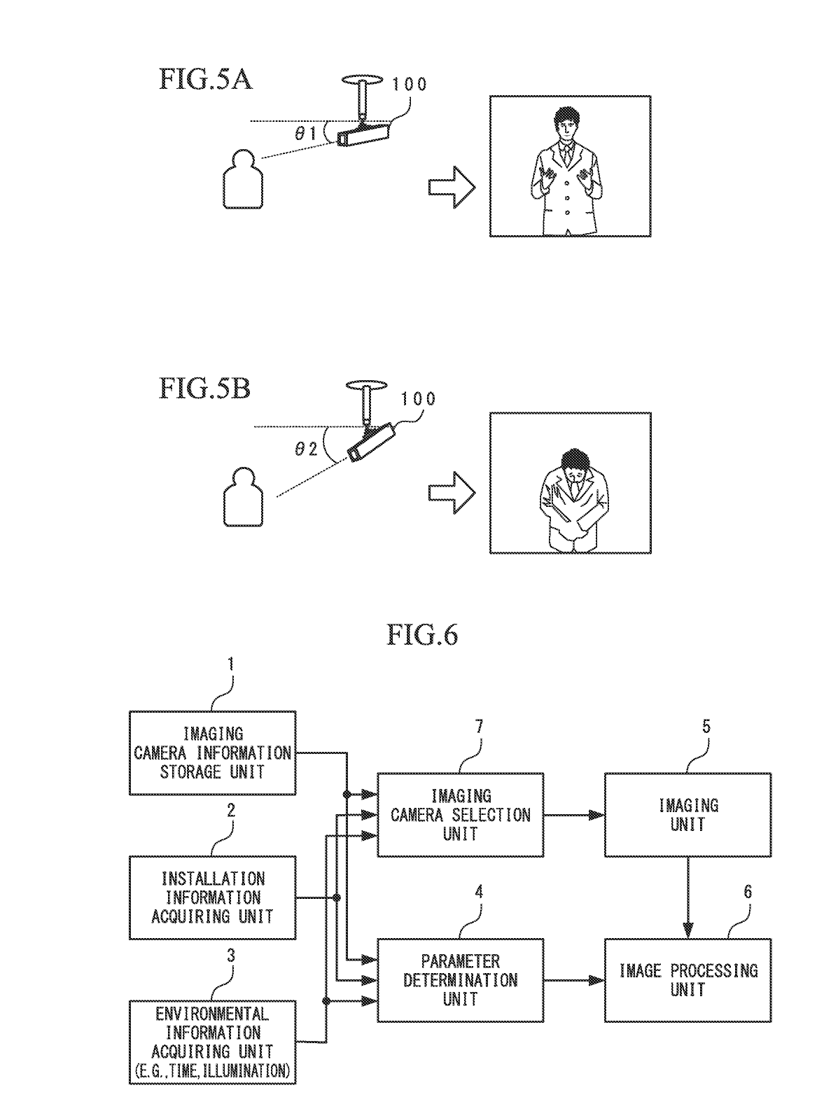

Moreover, in the detection of a person using the shape of the person, the parameter determination unit 4 determines an angle of depression θ of an installed camera unit as a parameter as shown in FIG. 5A and FIG. 5B. Here, in the image processing, the parameter determination unit 4 detects a person while switching a plurality of person shape dictionaries obtained by learning the shape of a person for each of angle of depression parameters in advance. This is because different angles of depression θ1 and θ2 of a camera result in different shapes of a person as shown in FIG. 5A and FIG. 5B.

Next, the imaging unit 5 acquires video from the camera units installed in the camera housing 100 (step S5).

Next, the image processing unit 6 performs image processing on the video acquired by the imaging unit 5 based on the above-described parameters determined by the parameter determination unit 4 (step S6).

In the case in which detection of a person is performed as the image processing, an image when no person is present is captured in advance using each camera unit, the image is registered as a background image, the difference between each input image and the background image is calculated for each input image, and a group of pixels for which the absolute value of the difference exceeds a predetermined threshold are extracted as a candidate region for the person. If the size of the candidate region is significantly different from the size obtained by the parameter determination unit 4, the image processing unit 6 determines that the candidate region does not correspond to a person, thereby making it possible to prevent false detections.

It is to be noted that not only parameters when image processing of a particular object, such as detection of a person, is performed but also a dictionary that have learnt processing targets and/or the type of an identification engine may be set as setting parameters for the image processing performed by the image processing unit 6.

Moreover, the image processing unit 6 may switch a target dictionary used in the image processing in accordance with the place where capturing is performed. For example, the image processing unit 6 switches the target dictionary used in the image processing in accordance with the type of the room taken by the installed camera units based on the rough sketch M of the room shown in FIG. 4. For example, with respect to a camera unit that captures the entrance, a detection process is performed using a person dictionary and a person extraction engine that uses the person dictionary. Moreover, with respect to a camera unit that captures a kitchen, a detection process is performed using a fire dictionary and a fire detection engine that uses the fire dictionary. By doing so, it is possible to realize detection of an intruder in the entrance and detection of a fire in a kitchen.

### B. Second Exemplary Embodiment

Next, a second exemplary embodiment of the present invention will be descried.

FIG. 6 is a block diagram illustrating a configuration of an imaging apparatus in accordance with the second exemplary embodiment of the present invention. It is to be noted that the same reference numerals are assigned to parts corresponding to those in FIG. 1, and the description thereof is omitted. As shown in FIG. 6, the present second exemplary embodiment includes an imaging camera selection unit 7 in addition to the above-described configuration of the first exemplary embodiment. The imaging camera selection unit 7 selects a camera unit with which the imaging unit 5 should perform capturing from among the plurality of camera units installed in the camera housing, based on the information of the imaging camera information storage unit 1, the installation information acquiring unit 2, and the environmental information acquiring unit 3 (the imaging camera information, the installation information, and the environmental information).

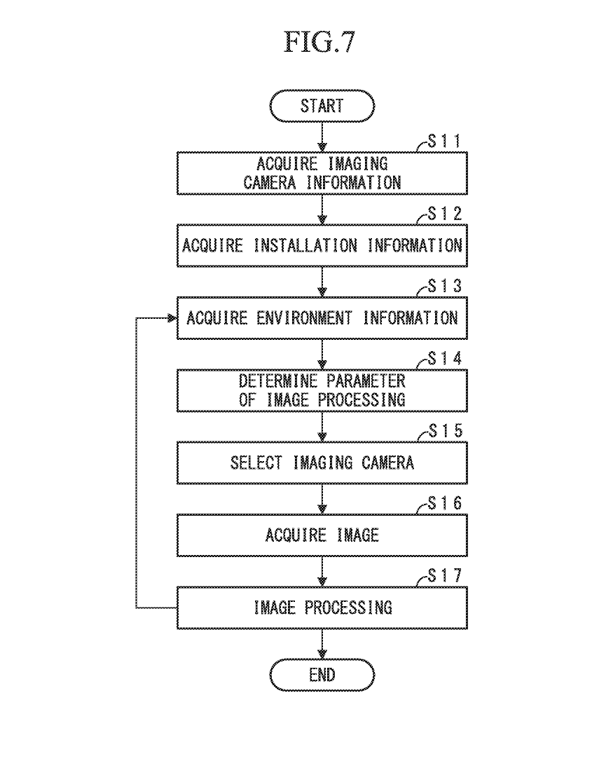

FIG. 7 is a flowchart describing an operation of the imaging apparatus in accordance with the present second exemplary embodiment. First, the parameter determination unit 4 acquires, from the imaging camera information storage unit 1, specifications of one or a plurality of camera units installed in the camera housing and positional information of the camera units relative to the camera housing (step S11).

Next, the installation information acquiring unit 2 acquires installation information of the camera housing (step S12). Moreover, the environmental information acquiring unit 3 acquires environmental information on the surrounding environment in which the camera housing is installed (step S13). Next, the parameter determination unit 4 determines parameters suitable for the processes performed by the image processing unit 6, based on the information of the imaging camera information storage unit 1, the installation information acquiring unit 2, and the environmental information acquiring unit 3 (the imaging camera information, the installation information, and the environmental information) (step S14).

The processes in the above steps S11, S12, S13, and S14 are the same as those in steps S1, S2, S3, and S4, respectively, shown in FIG. 2 in the above-described first exemplary embodiment.

Next, the imaging camera selection unit 7 selects a camera unit with which the imaging unit 5 should perform capturing from among the plurality of camera units installed in the camera housing, based on the information of the imaging camera information storage unit 1, the installation information acquiring unit 2, and the environmental information acquiring unit 3 (the imaging camera information, the installation information, and the environmental information) (step S15).

Next, the imaging unit 5 acquires video from the camera unit selected by the imaging camera selection unit 7 from among the camera units installed in the camera housing (step S16). Moreover, the image processing unit 6 performs image processing on images acquired by the imaging unit 5 based on the above-described parameters determined by the parameter determination unit 4 (step S17).

The processes in the above steps S16 and S17 are the same as those in the steps S5 and S6, respectively, shown in FIG. 2 in the above-described first exemplary embodiment.

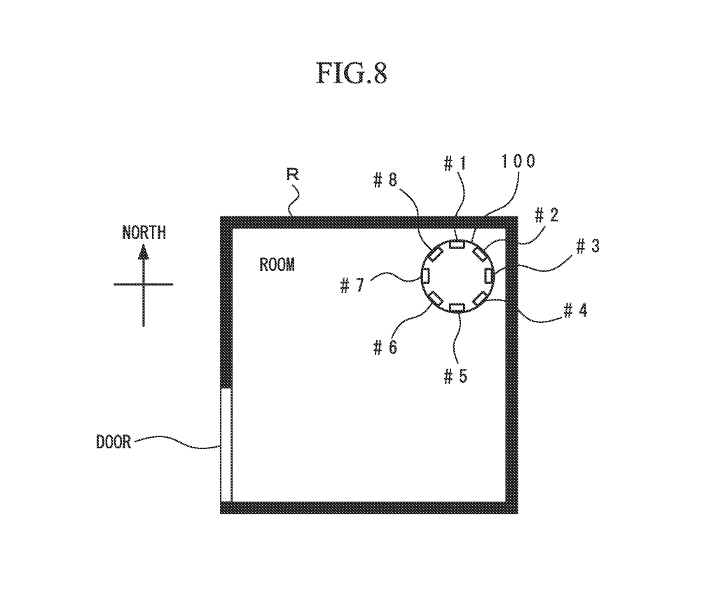

Here, an example will be described for the case in which the camera housing 100 that is provided with eight camera units is installed at the position in a room R as shown in FIG. 8, and camera numbers #1 to #8 are assigned to the eight camera units in the clockwise direction.

In this case, the fact that the camera housing 100 is installed at a corner of the room R as well as the fact that the camera unit having the camera number #1 is installed so as to face north can be known from the imaging camera information obtained by the imaging camera information storage unit 1 and the installation information obtained by the installation information acquiring unit 2. Accordingly, the imaging camera selection unit 7 calculates the distance from each camera unit to a wall based on these pieces of information, and determines that capturing should not be performed by a camera unit if the distance is less than or equal to a threshold. In the example shown in FIG. 8, the camera units having the camera numbers #1, #2, and #3 satisfy this condition. The threshold is set to the minimum distance between the wall and the camera in which a person can be present.

Moreover, the imaging camera selection unit 7 determines whether the brightness of the room is sufficient or not for capturing using a camera based on the environmental information obtained from the environmental information acquiring unit 3, and determines that capturing should not be performed by a camera unit in which the brightness is insufficient. For example, a determination as to whether the brightness of the room is sufficient or not for capturing using a camera is realized by determining whether the average of brightness values that have been previously acquired in each camera unit exceeds a threshold or not.

Alternatively, if the average of brightness values in a camera unit that captures the instant when a person passes is small, the imaging unit 5 may reduce the shutter speed of the camera unit to perform control so as to increase the brightness value sufficiently. Similarly, if the passing speed of a person on a screen is small, the number of frames acquired in one second may be reduced.

In this way, in the present second exemplary embodiment, it is possible to select a camera unit to be used in accordance with the environment. Therefore, even when a plurality of camera units are installed, unnecessary camera units are not used, so that power can be saved, and processing costs due to image processing can be reduced.

In addition, camera units of different types may be installed, and the type of camera units to be used may be selected in accordance with the environment. For example, when visible camera units and infrared camera units are installed, the visible camera units may be used if the brightness of a room, which is obtained as the environmental information, exceeds a threshold, and the infrared camera units may be used if the brightness of the room is below the threshold. Moreover, multi-spectral cameras may be installed, and a band to be used may be selected in accordance with the environmental information. Furthermore, when camera units having different zoom factors are installed, it is also possible to deal with the situation in which the size of an object varies depending on the environment.

Moreover, the room R shown in FIG. 8 has only one door, so that persons who go in and out of this room R are necessarily captured by the camera unit having the camera number #6, which captures the door. In such a case, only the camera unit having the camera number #6 may be operated under normal conditions, and if a person has been detected, the camera units having the camera numbers #4 to #8, with which there is a possibility that the person is captured, may be operated in accordance with the direction along which the person moves.

In this way, it is possible to select camera units to be used and control the acquiring rate of images in accordance with the installed position of the camera housing 100 and the surrounding environment. For this reason, it is possible to efficiently select camera units to be used in accordance with the environment in which the camera units are used by arranging redundant camera units in the camera housing 100 in advance.

With the above-described imaging apparatuses in accordance with the exemplary embodiments of the present invention, once the camera housing 100 is installed at an arbitrary place, parameters required for image processing are selected in accordance with the installed surrounding environment, and the image processing is performed. For this reason, for example, when an imaging apparatus in accordance with an exemplary embodiment of the present invention is installed on a ceiling or a wall of a building, if the imaging apparatus is installed at a place where existing signal lines and feeder lines of a fire alarm and so forth are available, it is possible to transmit video signals using the existing signal lines and supply electric power to the imaging apparatus from the feeder lines. Therefore, it is possible to reduce the installation costs.

Moreover, if video is distributed through a wireless LAN (local area network) and so forth or if electric power is supplied using a battery, no physical wiring is required, so that it is possible for a user to install the camera housing at any place without taking wiring and/or the perspective in each camera unit into consideration.

In the above-described first and second exemplary embodiments, it is possible to determine parameters relating to image processing by estimating the perspective and so forth of an object which is a processing target of each camera unit within an angle of view based on: imaging camera information relating to the shape and the size of a camera housing; specifications of installed camera units, such as the number of the camera units, the positions of the camera units, the numbers of pixels of the camera units, the focal lengths of the camera units, or camera lens distortion parameters of the camera units, and positional information of the camera units relative to the camera housing; installation information of the camera housing which includes the height at which the camera housing is installed, and the position and the orientation of the camera housing; and environmental information relating to the surrounding environment in which the camera housing is installed, the environmental information including the date and time, discrimination between an indoor area and an outdoor area, illumination conditions, a rough sketch of a room in the case of the indoor area, map information including surrounding buildings and so forth in the case of the outdoor area, without setting the parameters required for the image processing for each camera unit.

It is to be noted that a program for realizing all or part of the functions of the above-described imaging apparatuses may be recorded on a computer-readable recording medium, and the program recorded on this recording medium may be read and executed by a computer system, to thereby perform the process of each unit. It is to be noted that the “computer system” referred to here includes an OS (operating system) and hardware such as peripheral devices.

Moreover, the “computer system” includes a home-page presentation environments (or a display environment) when a WWW (World Wide Web) system is used.

Furthermore, the “computer readable recording medium” refers to a portable medium such as a flexible disk, a magneto-optical disk, a ROM (read only memory), or a CD (compact disc)-ROM, or a storage apparatus such as a hard disk embedded in the computer system. Additionally, the “computer readable recording medium” also includes a medium which dynamically stores the program for a short period of time such as a network like the Internet or a communication line when the program is transmitted through a communication circuit like a telephone line, and a medium which stores the program for a given period of time such as a volatile memory provided in a computer system that serves as a server or a client. In addition, the above program may realize part of the aforementioned functions, or it may realize the aforementioned functions in combination with a program already recorded in the computer system.

Although exemplary embodiments of the present invention have been described in detail with reference to the drawings, the specific configurations are not limited to these exemplary embodiments, and design change and so forth that does not depart from the gist of the present invention is also included.

This application is based upon and claims the benefit of priority from Japanese patent application No. 2011-058973, filed on Mar. 17, 2011, the disclosure of which is incorporated herein in its entirety by reference.

### Industrial Applicability

The present invention can be applied to, for example, systems which monitor all over a particular area for applications such as surveillance, care, or marketing. With the present invention, it is possible to determine parameters relating to image processing without setting the parameters required for the image processing for each of camera units.

### Description of Reference Numerals

1 imaging camera information storage unit

2 installation information acquiring unit

3 environmental information acquiring unit

4 parameter determination unit

5 imaging unit

6 image processing unit

7 imaging camera selection unit

1. An imaging apparatus comprising:
an imaging unit which includes one or a plurality of camera units and performs capturing;
an imaging camera information storage unit which stores imaging camera information which includes at least arrangement information and functional information of the one or the plurality of camera units;
an installation information acquiring unit which acquires installation information of the imaging unit;
an environmental information acquiring unit which acquires environmental information surrounding the imaging unit;
a parameter determination unit which determines a parameter of image processing for the one or the plurality of camera units based on the imaging camera information, the installation information, and the environmental information; and
an image processing unit which performs image processing on video taken using the one or the plurality of camera units of the imaging unit, based on the parameter determined by the parameter determination unit.

2. The imaging apparatus according to claim 1, wherein the imaging unit includes the plurality of camera units,
the imaging apparatus further comprises an imaging camera selection unit which selects a camera unit that performs the capturing, based on the imaging camera information, the installation information, and the environmental information, and
the image processing unit performs the image processing on the video taken using the camera unit selected by the imaging camera selection unit, based on the parameter determined by the parameter determination unit.

3. The imaging apparatus according to claim 2, wherein the imaging camera selection unit calculates the distance from each of the plurality of camera units to a wall based on the imaging camera information and the installation information, and selects a camera unit for which the distance is greater than or equal to a threshold.

4. The imaging apparatus according to claim 2, wherein the imaging camera selection unit determines whether or not brightness acquired by each of the plurality of camera units is sufficient to perform the capturing based on the imaging camera information, the installation information, and the environmental information, and selects a camera unit for which the brightness is sufficient to perform the capturing.

5. The imaging apparatus according to claim 1, wherein the parameter determination unit dynamically determines the parameter.

6. An imaging method comprising:
storing imaging camera information including at least arrangement information and functional information of one or a plurality of camera units that are provided in an imaging unit;
acquiring installation information of the imaging unit;
acquiring environmental information surrounding the imaging unit;
determining a parameter of image processing for the one or the plurality of camera units based on the imaging camera information, the installation information, and the environmental information;
capturing video using the imaging unit; and
performing image processing on video taken using the one or the plurality of camera units of the imaging unit based on the determined parameter.

7. The imaging method according to claim 6, wherein the imaging unit includes the plurality of camera units,
a camera unit that performs the capturing is selected based on the imaging camera information, the installation information, and the environmental information, and
the image processing is performed on the video taken using the selected camera unit based on the determined parameter.

8. The imaging method according to claim 7, wherein the distance from each of the plurality of camera units to a wall is calculated based on the imaging camera information and the installation information, and a camera unit for which the distance is greater than or equal to a threshold is selected.

9. The imaging method according to claim 7, wherein a determination is made as to whether or not brightness acquired by each of the plurality of camera units is sufficient for performing the capturing based on the imaging camera information, the installation information, and the environmental information, and a camera unit for which the brightness is sufficient for performing the capturing is selected.

10. A program which causes a computer of an imaging apparatus to execute:
an imaging function of capturing video using an imaging unit that includes one or a plurality of camera units;
an imaging camera information storage function of storing imaging camera information including at least arrangement information and functional information of the one or the plurality of camera units;
an installation information acquiring function of acquiring installation information of the imaging unit;
an environmental information acquiring function of acquiring environmental information surrounding the imaging unit;
a parameter determination function of determining a parameter of image processing for the one or the plurality of camera units based on the imaging camera information, the installation information, and the environmental information; and
an image processing function of performing image processing on video taken using the one or the plurality of camera units of the imaging unit based on the parameter determined by the parameter determination function.

11. The program according to claim 10, wherein the imaging unit includes the plurality of camera units,
the program causes the computer to further execute an imaging camera selection function of selecting a camera unit that performs the capturing based on the imaging camera information, the installation information, and the environmental information, and
the image processing function performs the image processing on the video taken using the camera unit selected by the imaging camera selection function based on the parameter determined by the parameter determination function.

12. The imaging apparatus according to claim 2, wherein the parameter determination unit dynamically determines the parameter.

13. The imaging apparatus according to claim 3, wherein the parameter determination unit dynamically determines the parameter.

14. The imaging apparatus according to claim 4, wherein the parameter determination unit dynamically determines the parameter.
